(19) United States
(12) Patent Application Publication
(10) Pub. No.: US 2007/0192198 A1
(43) Pub. Date: Aug. 16, 2007

(54) System and method for leveraging a payment authorization environment for offering and fulfilling the cross selling of products to existing customers, up selling, and acquisition of new customers

(75) Inventor: William S. Schwarz, Scottsdale, AZ (US)

Correspondence Address: FITZPATRICK CELLA (AMEX), 30 ROCKEFELLER PLAZA, NEW YORK, NY, 10112, US

(73) Assignee: American Express Travel Related Services Co., Inc., New York, NY (US)

(21) Appl. No.: 11/175,205

(22) Filed: Jul. 7, 2005

(51) Int. Cl. G06Q 30/00

(52) U.S. Cl. 705/26

(57) ABSTRACT

A method, system and computer program product for communicating to a consumer one or more offers at a merchant communication device. Predefined offers are stored in a database. A portal selects one or more of the predefined offers, which are then communicated to the consumer through the merchant communication device. The consumer's response to the at least one offer is accepted and the transaction is completed accordingly.

### BACKGROUND OF THE INVENTION

1. Field of the Invention

The present invention generally relates to payment authorization systems, and more particularly to making offers during a payment authorization process.

2. Related Art

In a typical payment authorization system, transaction account information is captured from a financial transaction instrument such as a credit card. The information is read from the card's magnetic strip by swiping it through a communication device such as a point-of-sale terminal, or by entering the instrument and payment information into the merchant or service provider's payment device (e.g., PC- or mobile device-based software). Information from the instrument (e.g., cardholder name, card type, account number, expiration date) is combined with information about the transaction (e.g., dollar amount and merchant identifier) to create an authorization request. The merchant communication device transmits the authorization request to a bank or bank/processor alliance (also referred to as an acquirer) that is in the business of processing credit card transactions for businesses.

The authorization request is then forwarded from the acquirer to an authorization system which verifies that the transaction account has sufficient funds, available line of credit, or passes other risk assessment criteria to cover the amount of the transaction. Typically, a response in the form of a code is transmitted back to the merchant communication device as an approval (with authorization number), referral or declination.

Sales representatives frequently take advantage of the time it takes to process an authorization request to make offers for goods or services to the consumer. Tactics include up-selling, cross-selling, and acquiring new customers. Up-selling is the process of offering a consumer who just placed an order, either a bigger or better deal on a more expensive item than what they just bought, but in the same category. This can also include the upgrading of the card product such as upgrading from a normal card account to a higher rated card account (e.g., platinum).

Cross-selling refers to offering consumers additional items in different categories from what has just been bought. In the context of retail, for instance, cross-selling is the process of selling between and among departments to encourage larger transactions and to make it more convenient for the consumer to do related-item shopping. In some cases cross-selling is designed to widen the consumer's reliance on a particular merchant and decrease the likelihood of the consumer switching to a competitor.

Acquiring new customers refers to using the overall sale process to market a competing product outside the merchant's domain. In the context of retail, for instance, a merchant may have an affinity with a specific card issuer and when other cards are presented for use, the merchant and the affinity card issuer may attempt to acquire the customer as a new customer of the affinity card.

Given the foregoing, what is needed is a system, method and computer program product for leveraging a payment authorization environment for offering and fulfilling the cross selling of products to existing customers, up selling, and acquisition of new customers.

### BRIEF DESCRIPTION OF THE INVENTION

The present invention meets the above-identified needs by providing a system, method and computer program product for leveraging a payment authorization environment to facilitate a greater amount of successful up-selling, cross-selling and customer acquisition.

In accordance with one embodiment of the present invention, there is provided a system, method and computer program for communicating to a consumer at least one offer in response to an authorization request. The embodiment includes a database operable to store predefined offers based on information about the consumer. A portal unit selects an offer, if one exists, from the plurality of predefined offers, based on the authorization request. If one exists, then the portal unit responds to the authorization request with the offer(s). The merchant communication device accepts from the consumer a response to the offer(s) and the authorization system completes the transaction based on the response to the offer(s).

An advantage of the present invention is that it provides valuable consumer interaction when the consumer is performing a transaction.

Another advantage of the present invention is that it provides the merchant with offers to present a consumer which are targeted to that consumer.

Another advantage of the present invention is that it provides the merchant with the ability to sell products at the right moment.

Yet another advantage of the present invention is that it decreases processing companies redemption costs for transaction account related rewards.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary transaction account authorization system in which the present invention, in an embodiment, would be implemented.

FIG. 2 is a flowchart illustrating a transaction account authorization process according to one embodiment of the present invention.

FIG. 3 is a block diagram of an exemplary computer system useful for implementing the present invention.

### DETAILED DESCRIPTION

I. Definitions

The terms “user”, “end user”, “consumer”, “customer”, “participant”, “individual”, and/or the plural form of these terms are used interchangeably throughout herein to refer to those persons or entities capable of accessing, using, being affected by and/or benefiting from the present invention.

The terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial transaction instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

“Open cards” are financial transaction cards that are generally accepted at different merchants. Examples of open cards include the American Express Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed.

For example, if a consumer deposits ten dollars of value into the account associated with the stored value card, the card may only be used for payments up to ten dollars.

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication devices, such as, for example, a telephone network, intranet, the global, public Internet, a point of interaction device (e.g., a point of sale (“POS”) device, electronic cash register (“ECR”) personal digital assistant (“PDA”) mobile telephone, kiosk, fat device, etc.), online communications, off-line communications, wireless communications, and/or the like.

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A consumer account number may be, for example, a sixteen-digit credit card number. Each credit card issuer has its own numbering system, such as the fifteen-digit numbering system used by American Express Company of New York, NY. Each issuer's credit card numbers comply with that company's standardized format such that an issuer using a sixteen-digit format will generally use four spaced sets of numbers in the form of:
N₁N₂N₃N₄N₅N₆N₇N₈N₉N₁₀N₁₁N₁₂N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the consumer, card holder or cardmember.

A merchant account number may be, for example, any number or alpha-numeric characters that identifies a particular merchant for purposes of card acceptance, account reconciliation, reporting and the like.

II. Overview

The present invention is directed to a system, method and computer program product for extending the payment authorization process by providing a means of selling additional products and/or services to an individual during a transaction. More particularly, the present invention creates a list of pre-approved offers using data from a variety of sources. The offers can be, for example, discounts on companion purchases, an upgrade on a current purchase, new products obtainable at a merchant location, and new products offered in conjunction with the merchant or an issuer in an attempt gain new customers. Individuals are eligible for new products, upgrades, or other items, the offer for which have been previously stored in a database. The offers are tailored to a particular individual based on various criteria, such as the individual's credit history, account transaction history, and/or purchases made in the past. For example, if the holder recently purchased a plane ticket for travel to the Caribbean, the offer might be a discount on a bathing suit.

After a transaction authorization request is transmitted from the merchant communication device, an additional step occurs that scans the list of previously stored offers and appends any relevant offers to the authorization response. The additional step of scanning for offers can occur in parallel or synchronously to the authorization request. Alternatively, an offer can be based on a set of rules applied to data received from feeds from various sources.

III. System

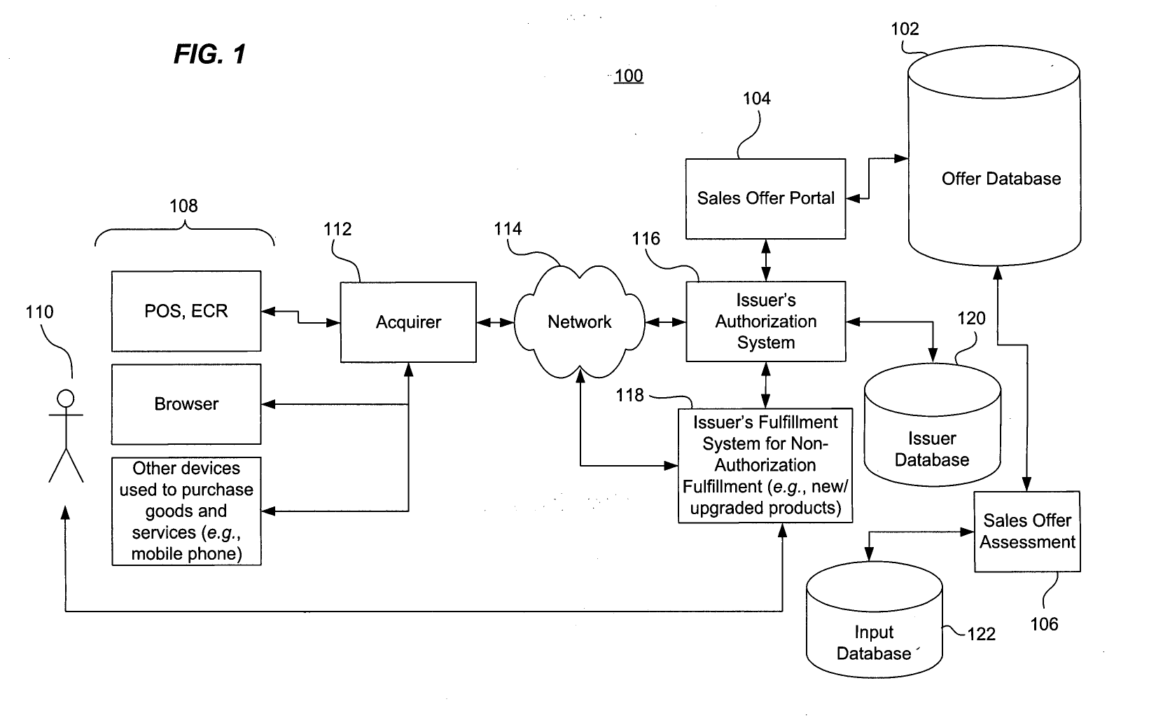

FIG. 1 is a system diagram of an exemplary authorization system 100 in which the present invention, in an embodiment, would be implemented. It should be understood that the example operating environment in FIG. 1 is shown for illustrative purposes only and does not limit the invention. In fact, after reading the following description, it will be apparent to one skilled in the relevant art(s) how to implement the following invention in alternative embodiments.

System 100 includes a merchant communication device 108 for transmitting an authorization request to acquirer 112. Merchant communication device 108 can be, for example, a telephone network, intranet, a global, public Internet, a point of interaction device (e.g., a point of sale (“POS”) device, electronic cash register (“ECR”), personal digital assistant (“PDA”), mobile telephone, kiosk, etc.), online communications, off-line communications, wireless communications, and the like. Communication device 108 is further adapted to append additional data to the authorization request indicating that merchant communication device 108 is configured to handle sales-offer functions.

Communication device 108 transmits the authorization request including the appended data to acquirer 112. Acquirer 112 then forwards the request to either authorization system 116 or fulfillment system 118 via network 114. As those skilled in the art will understand, acquirer 112, network 114, issuer authorization system 116 and/or fulfillment system 118 may be operated by the same entity.

Authorization system 116 is an intermediary transaction service which recognizes the financial transaction instrument's issuer and verifies that the consumer's transaction account is valid. In cases where the authorization system is not associated with the transaction account issuer the role of the authorization system 116 is to transmit an authorization request to a transaction account issuer or issuing bank. Thus, it may be the case that the issuer directly verifies that the amount of the transaction is less than the remaining credit limit (if such a credit limit exists). In other cases, an issuing bank indirectly performs the verifications. The present invention is applicable to all such operating environments. For simplicity authorization system 116 and fullfillment system 118 illustrated in FIG. 1 are associated with the issuer.

Authorization system 116 detects whether a sales offer opportunity exists either from the presence of the data appended to the request, or from information stored on database 120 about merchant communications device 108. Authorization system 116 then transmits either the entire request, a portion of the request, or a coded version of the request, to sales-offer portal 104 which determines whether any offers should be made to consumer 110.

Portal 104 uses the data from the authorization request to locate a record on offer database 102 corresponding to the individual consumer. The lookup data can be based on (but is not limited to) the consumer's name, address, account number, originating merchant, and consumer location. Database 102 includes a list of pre-approved, personalized offers such as upgrades to current products, e.g., an upgrade from a gold card to a platinum card. Database 102 can further include new products to offer consumer 110, such as a personal credit card for an existing business card holder. Still further, database 102 can include offers for companion merchandise or services, such as a personalized offer based on knowledge of prior purchases.

Offer database 102 creates the list of pre-approved offers using data from a variety of sources, such as input from credit scoring, transaction history, current relationships, demographics and personal history databases, to name a few. Collectively, such sources are illustrated in FIG. 1 as input database 122. Feeds from these sources are processed by a sales-offer assessment system 106.

For cross-sell and new customer acquisition, sales-offer assessment system 106 performs risk assessments as if the user had requested an upgrade, or a new product. A risk assessment process analyzes credit history, external credit information, demographics, and other data. If the user is approved for the upgrade or new product, an indication is made to the user's record which identifies any pre-approved offers. Credit lines and other attributes of the offers can be included in the offer.

For up-selling, recent transaction history, risk assessment on the financial impacts of the various offers, customer preferences, seasonal attributes and other data can be used to identify pre-approved offers for later transactions. On a periodic basis, pre-approved offers can be reassessed with updated information, after which an offer can be removed, enhanced, or left the same.

Portal 104 scans the aggregation of offers in database 102 for any that would be appropriate for consumer 110, and if one exists returns the details to authorization system 116. Alternatively, even if a record exists in offer database 102 for the consumer, it may be the case that based on other factors, no offers are made to consumer 110. In such a case, a message indicating that no offer is being presented is transmitted back to authorization system 116.

Authorization system 116 creates a reply message by bundling the resolution of the initial authorization (e.g., sale was approved or denied) along with any offers received from portal 104. After the reply is created, authorization system 116 transmits the reply to communication device 108 via acquirer 112 and network 114.

The form in which the offer(s) is presented to consumer 110 depends on the type of merchant communications device being used. For example, if the offer is being made over the Internet, then the offer can be made via a Web browser running an Internet application. The offers can be presented in the form of graphics, text, and other data for displays, or by printing the offer on a printing device. Alternatively, a merchant representative can make the offer verbally.

The underlying data for communicating the offer can be supplied in the form of messages or represented by codes or other shortcuts which can be interpreted by merchant communications device 108. If consumer 110 accepts an offer, merchant communication device 108 transmits the accepted offer to an issuer fulfillment system 118 which fulfills the request. Bypassing authorization system 116 is preferable for transactions typically not handled by authorization system 116, such as upgrading a level of service or issuing a new transaction account.

In the case of a new or upgraded product offer, one or more messages will be transmitted to the particular issuer systems (not shown) such as account receivables, consumer relationship, media issuance, consumer notification, and the like via authorization system 116 and network 114. Preferably, authorization system 118 processes purchase offers, such as a discount for another purchase. Thus, any prior offer information and pre-authorization assessments related to the new offers can be handled simultaneously, thereby expediting the entire process. Thus, consumer 110 need not wait for yet another response to an authorization request because the consumer's transaction limit can be transmitted from authorization system 116 to merchant communications device 108.

The consumer may receive new media (e.g., financial transaction instrument) or other information at the time of purchase, through the merchant or by other means such as postal mail or e-mail. Furthermore, the original authorization of the sale can be performed in parallel with or after receiving a response from sales-offer portal 104.

In another embodiment of the present invention, a transaction instrument (e.g., card) is offered by two organizations, jointly. This is known in the art as an “affinity card.” One is a credit card issuer and the other can be, for example, a professional association, special interest group or other non-bank organization. When the sale takes place, merchant communication device 108 sends the authorization to a first issuer, and the offer check goes to a second issuer. Merchant communication device 108 aggregates the responses and informs the cardholder of the pre-approved affinity card offer. This enables one entity to market to another entity's cardholder.

IV. Process

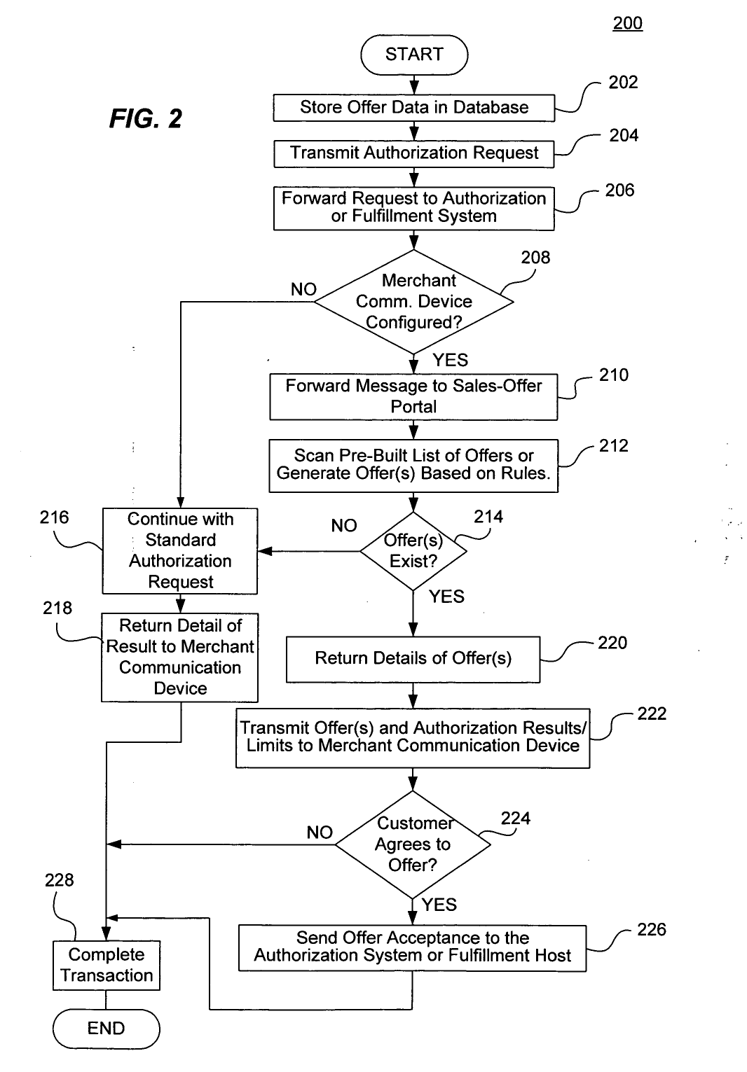

FIG. 2 is a flowchart illustrating an authorization process according to one embodiment of the present invention. At step 202, offer database 102 is supplied with a list of pre-approved offers which are tailored to particular individuals by processing data from a variety of sources (shown as input database 122) using sales-assessment system 106.

When a consumer buys goods or services using a financial transaction instrument, as part of the process, the merchant will require a transaction authorization. Merchant communication device 108 is used to create and forward a authorization request to the issuer's authorization system 116 for the authorization. In an exemplary embodiment of the present invention, the request follows a path that includes acquirer 112, network 114, and eventually the instrument issuer's authorization system 116. However, other paths leading to-issuer's authorization system 16 are possible.

Referring to FIG. 2, at step 204, when a consumer purchases a product or service using a financial transaction instrument, communication device 108 forwards the authorization request message with appended data to the entity providing the acquirer role. In particular, for point of interaction devices such as POS devices, the request message from the end device contains magnetic stripe information (e.g., name and account number) and the appended data includes other consumer information such as telephone number or ZIP code. For text entry devices (e.g., browsers, fat clients, telephones) the request message includes information such as name, account number, address, telephone number.

At step 206, acquirer 112 forwards the request authorization to issuer's authorization system 116 and/or fulfillment system 118 via network 114. At step 208, authorization system 116 detects whether an opportunity exists to provide merchant communication device 108 with offers to make to consumer 110. The determination can be by detecting the presence of predefined data in the authorization request or by cross-referencing an identifier of merchant communication device 108 with records in an issuer database 120.

At step 210 an inquiry is transmitted to sales-offer portal 104 to determine whether any offers should be made to consumer 110. The inquiry includes the collected information such as name, address, account number, originating merchant and consumer location. The authorization of the sale can be performed in parallel to or after receiving a response from the sales-offer portal 104.

In step 212, portal 104 scans its records corresponding to consumer 110 and returns a response with offers, if any exist, as shown at steps 214 and 220. In an exemplary embodiment of the present invention, portal 104 scans a list of offers and selects zero, one, or more offers for the consumer. Portal 104 then creates a reference number, an expiration date, and a description (i.e., by a symbol or other shorthand, or a full text message or combination of both). Offers are then returned to issuer's authorization system 116 in the form of the reference number, expiration, and description. Both portal 104 and authorization system 116 save the information for any subsequent fulfillment activities.

Authorization system 116 creates and transmits a reply message by bundling the resolution of the actual authorization request (e.g., sale approval or denial) along with any offers returned by portal 104. In an exemplary embodiment of the present invention the actual authorization request reply includes a reference number, expiration, description, and any offer(s). The reply with any offer(s) is transmitted back to the network 114, acquirer 112, and eventual to merchant communication device 108.

If at least one offer has been made, merchant communication device 108 receives the offers and communicated them to consumer 110 as shown at step 222. Such communication can be performed in a variety of manners, such as by displaying the offers on a terminal screen for the merchant to read, printed on the consumer's receipt, or displayed on the consumer's WWW browser.

If consumer 110 accepts an offer at step 224, merchant communication device 108 transmits the accepted offer to issuer authorization system 116 or fulfillment system 118 as shown at step 226. If it is determined at step 214 that an offer does not exist, then at step 216 the original authorization request is handled and at step 218 the authorization results are transmitted to merchant communication device 108 and at step 228 the transaction details are then completed.

Merchant communication device 108 communicates a message to issuer fulfillment system 118 as to whether an offer has been accepted in a variety of manners. For example, a POS device can be programmed to provide a prompt/reply option, or a terminal or browser (e.g., ECR or website) can be programmed to provide an input screen. In an exemplary embodiment of the present invention, the message to fulfillment system 118 includes a reference number and the consumer's acceptance or rejection of the offer. Alternatively, the merchant need not communicate a consumer's rejection of an offer and proceed with the original transaction. The message is transmitted to fulfillment system 118 through acquirer 112, network 114 and issuer's authorization system 116. The message can also bypass one of these entities, e.g., as shown in FIG. 1 bypassing issuer's authorization system.

In an exemplary embodiment of the present invention, fulfillment system 118 orchestrates with other systems to fulfill the request (not shown). In the case of an upgrade to a transaction instrument product (e.g., card), this process would include one or more messages to the issuer systems such as account receivables, customer relationship, media issuance, consumer notification, and the like. In the case of an offer involving a purchase (e.g., discounts for another purchase), authorization system 116 receives this information and handles the transaction.

The reference number of the transaction is used by the appropriate systems to fulfill the offer. In the case of a purchase, the reference number is used to validate an offer was made and that the offer has not expired. Depending on the offer, it may be a pre-approved (e.g., a one hour offer for a discount on a small ticket item) and not require a credit assessment. Other offers may not be completely pre-approved and may require and up-to-date credit assessment be preformed (e.g., 30 day offer for a relatively expensive item). Fulfillment system 118 then creates a reply message validating the offer was fulfilled or was rejected (e.g., due to the expiration of the credit instrument or rejected credit assessment). The consumer may receive new media (e.g., card) or other information by other means.

Finally, at step 228 the transaction is completed, whether or not an offer is accepted.

V. Example Implementations

The present invention (i.e., system 100, process 200 or any part(s) or function(s) thereof) may be implemented using hardware, software or a combination thereof and may be implemented in one or more computer systems or other processing systems. However, the manipulations performed by the present invention were often referred to in terms, such as presenting or offering, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

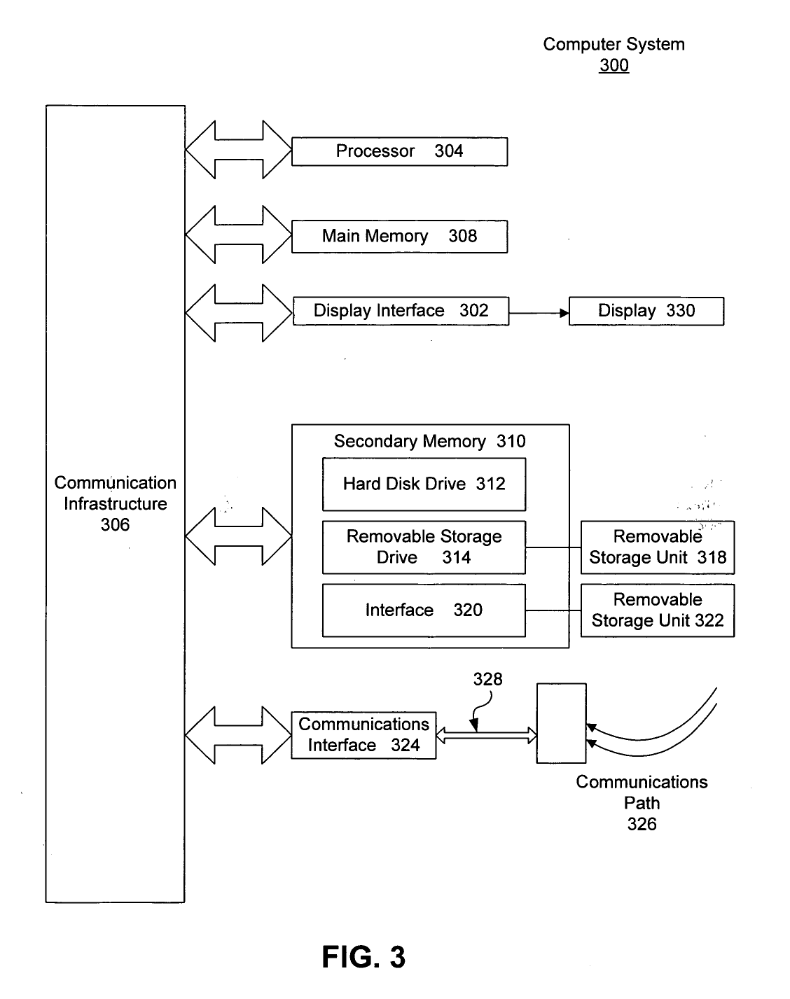

In fact, in one embodiment, the invention is directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPR POM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 326 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment, where the invention is implemented using software, the software may be stored in a computer program product and loaded into computer system 300 using removable storage drive 314, hard drive 312 or communications interface 324. The control logic (software), when executed by the processor 304, causes the, processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

VI. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for communicating to a consumer at least one offer at a merchant communication device, comprising the steps of:
storing a plurality of predefined offers based on information about the consumer;
receiving an authorization request from the merchant communication device;
selecting the at least one offer from the plurality of predefined offers, based on the authorization request;
responding to the authorization request with the at least one offer;
accepting from the consumer a response to the at least one offer; and
completing a transaction based on the response to the at least one offer.

2. The method of claim 1, further comprising the step of:
determining whether the merchant communication device is configured to present the at least one offer to the consumer based on information appended to the authorization request indicating the ability of the merchant communication device to present the at least one offer to the consumer.

3. The method according to claim 1, further comprising the step of:
verifying that a transaction account of the consumer is authorized to accept the at least one offer before accepting from the consumer the response to the at least one offer.

4. The method according to claim 1, further comprising the step of:
bypassing an authorization system to fulfill the at least one offer.

5. A system for communicating to a consumer at least one offer in response to an authorization request received from a merchant communication device, comprising:
a database operable to store a plurality of predefined offers based on information about the consumer;
a portal unit operable to select the at least one offer from the plurality of predefined offers, based on the authorization request, and to respond to the authorization request with the at least one offer; and
an authorization system operable to receive from the merchant communication device a response to the at least one offer and complete a transaction based on the response to the at least one offer.

6. The system of claim 5, wherein the authorization system is further operable to determine whether the merchant communication device is configured to present the at least one offer to the consumer based on information appended to the authorization request indicating the ability of the merchant communication device to present the at least one offer to the consumer.

7. The system according to claim 5, wherein the authorization system is further operable to verify that a transaction account of the consumer is authorized to accept the at least one offer before accepting from the consumer the response to the at least one offer.

8. The system according to claim 5, further comprising:
a fulfillment system operable to bypass the authorization system and fulfill the at least one offer.

9. A computer program product comprising a computer usable medium having control logic stored therein for causing a computer to communicate to a consumer at least one offer through a merchant communication device, said control logic comprising:
first computer readable program code means for causing the computer to store a plurality of predefined offers based on information about the consumer;
second computer readable program code means for causing the computer to receive an authorization request from the merchant communication device;
third computer readable program code means for causing the computer to select the at least one offer from the plurality of predefined offers, based on the authorization request;
fourth computer readable program code for causing the computer to respond to the authorization request with the at least one offer;
fifth computer readable program code means for causing the computer to accept from the consumer a response to the at least one offer; and
sixth computer readable program code means for causing the computer to complete a transaction based on the response to the at least one offer.

10. The computer program product of claim 9, further comprising:
seventh computer readable program code means for causing the computer to determine whether the merchant communication device is configured to communicate the at least one offer to the consumer based on information appended to the authorization request indicating the ability of the, merchant communication device to present the at least one offer to the consumer.

11. The computer program product of claim 9, further comprising:
seventh computer readable program code means for causing the computer to verify that a transaction account of the consumer is authorized to accept the at least one offer before accepting from the consumer the response to the at least one offer.

12. The computer program product of claim 9, further comprising: seventh computer readable program code means for causing the computer to bypass an authorization system to fulfill the at least one offer.
